(19) United States
(12) Patent Application Publication
(10) Pub. No.: US 2024/0280762 A1
(43) Pub. Date: Aug. 22, 2024

(54) CONNECTORIZATION AND COUPLING OF OPTICAL-FIBER COLLIMATORS

(71) Applicant: Electro-Optics Technology, Incorporated, Traverse City, MI (US)

(72) Inventors: Benjamin TANNER, Traverse City, MI (US); Conor BYRNE, Traverse City, MI (US); Joseph MAMBOURG, Spring Lake, MI (US); David SCERBAK, Traverse City, MI (US)

(73) Assignee: Electro-Optics Technology, Incorporated, Traverse City, MI (US)

(21) Appl. No.: 18/435,621

(22) Filed: Feb. 7, 2024

Related U.S. Application Data
(60) Provisional application No. 63/447,181, filed on Feb. 21, 2023.

(51) Int. Cl. G02B 6/38

(52) U.S. Cl. CPC G02B 6/3853

(57) ABSTRACT

A connectorized fiber collimator includes a holder, a bearing, and a fiber collimator. The holder has a frontside, with a planar reference surface, and a backside. An outer circumferential surface of the holder defines a circular reference circumference. The frontside or backside has a recess. A through hole, at the recess, extends from the frontside to the backside. The bearing has a spherical surface seated in the recess. The fiber collimator is seated in a bore through the bearing. Rotation of the bearing in the recess adjusts pointing relative to a longitudinal axis of the connectorized fiber collimator. Lateral dimensions of the fiber collimator are undersized relative to the bore to facilitate offset adjustment relative to the longitudinal axis. Accurate alignment of the connectorized optical-fiber collimator in fiber-to-fiber and fiber-free-space couplings is achieved through mechanical registration of the planar reference surface and the circular reference circumference.

### CROSS REFERENCE TO RELATED APPLICATIONS

This application claims the benefit of U.S. Provisional Application No. 63/447,181, filed Feb. 21, 2023, the contents of which is incorporated herein by reference.

### TECHNICAL FIELD OF THE INVENTION

The present invention relates to the connectorization of optical-fiber collimators. The present invention relates in particular to the coupling of high-power laser light into or between alignment-sensitive optical fibers such as single-mode fibers.

### DISCUSSION OF BACKGROUND ART

Optical fibers offer a robust and flexible solution for transporting laser light from one location to another. Optical fibers are becoming ubiquitous for transporting laser light between optical components, between a laser source and an optical component, between a laser source and a workpiece to be processed by the laser light, and between different modules of a laser apparatus. In many applications, optical fibers have replaced free-space beam-steering optics. Free-space beam-steering optics are more sensitive to environmental effects and other disturbances than optical fibers, and optical fibers therefore provide a more reliable solution. Optical fibers may also save space and be generally more convenient than free-space beam-steering optics. In some scenarios, the challenges associated with free-space transport of laser light are insurmountable and optical fibers are the only viable solution.

The performance of a laser-light transport solution based on optical fibers depends on the laser light being efficiently coupled into an optical fiber in the first place. In many systems, the laser light must also be coupled between optical fibers. Each time the laser light is coupled from one optical fiber to another, the potential exists for a substantial fraction of the laser light to be lost. Thus, much effort has been devoted to making low-loss fiber-to-fiber couplings that are reliable, practical, compact, inexpensive, etc. The different types of fiber-to-fiber couplings can generally be divided into two categories: splices and connector-based couplings. Some applications require that the fiber-to-fiber coupling can be de-mated and re-mated. For example, it may be critical that a fiber-optic module or an optical fiber can be disconnected and replaced, or that a laser source can be disconnected from a laser processing head (e.g., a laser welding head) for service or replacement. In these situations, connector-based fiber-to-fiber couplings are useful.

Connector-based fiber-to-fiber couplings are convenient and enable modularity, but reliably achieving the proper alignment between the two fiber ends can be difficult, especially for single-mode optical fibers and other alignment-sensitive optical fibers, such as large-mode-area optical fibers that can guide both the highest-brightness low-order mode and higher-order modes with low loss. In a typical connector-based fiber-to-fiber coupling, each fiber end is connectorized with a ferrule, and the two connectors (ferrules) are threaded onto opposite ends of an alignment sleeve. The ferrules and alignment sleeve may be designed to butt the two fiber ends against each other, for example using a spring-loaded mechanism. Conical surfaces may help axially align the two fiber ends with each other. Still, the butt-coupled design is relatively sensitive to lateral misalignment between the two fiber ends, and it may not be possible to reliably achieve low loss for alignment-sensitive optical fibers such as single-mode fibers. This issue may be alleviated by expanding the laser beam between the two fibers. In such an expanded-beam design, the fiber-ends are a distance away from each other and each ferrule includes a collimation lens. The diameter of the expanded laser beam may exceed that of the fiber cores by one or more orders of magnitude, thereby greatly reducing the sensitivity to lateral alignment error. Unfortunately, the expanded-beam design is more sensitive to angular misalignment.

Particular challenges arise when optical fibers are used to transport high-power laser light, for example with an average power in the kilowatt (kW) range or higher, or a peak power of about a megawatt (MW) or more. In these situations, it is common to use large-mode-area optical fibers in order to reduce deleterious effects within the fiber. It is also typically necessary to terminate the large-mode-area optical fibers with a larger-diameter end cap. The end cap allows the laser beam to expand to a large diameter before passing through surfaces exposed to outside contamination (e.g., dust particles). If the fiber end itself was exposed, the high intensity of the laser light at the fiber end would likely lead to damage when interacting with contaminants on the fiber end. End-cap termination rules out butt-coupling. The expanded-beam design is a viable option, and a typical fiber terminator includes or is coupled with a collimation lens. However, at least for laser light with a high average power, special care must be taken to minimize and/or manage loss in order to prevent connector parts from overheating. Some connector-based fiber-to-fiber couplings, specifically configured for laser light with a high average power, replace the conventional alignment sleeve with a water- or air-cooled chamber to manage the heat load from coupling losses. This chamber may further include one or more sensors for monitoring the health of the fiber connectors.

### SUMMARY OF THE INVENTION

Disclosed herein is an optical fiber connector that enables reliable, reproducible, and accurate optical alignment between two optical-fiber collimators each connectorized with the present fiber connector, or between a free-space optical module and an optical-fiber collimator connectorized with the present fiber connector. Once an optical-fiber collimator is connectorized with the present fiber connector, the reliable and reproducible alignment accuracy is based on mechanical registration of reference surfaces of the fiber connector. For example, in a fiber-to-fiber coupling, reference surfaces of the two fiber connectors may be registered against each other and a fixture. In a fiber-free-space coupling, the reference surfaces of a single fiber connector may be registered against a fixture. The fixture then serves as an alignment reference for an external system configured to either deliver a free-space laser beam to the optical-fiber collimator or receive a free-space laser beam from the optical-fiber collimator.

The reference surfaces of the present fiber connector may be manufactured with high precision. In conjunction with the optical-fiber collimator being optically aligned relative to the reference surfaces in the initial connectorization process, precision manufactured reference surfaces eliminate the need for active alignment of the connectorized optical-fiber collimator when completing a fiber-to-fiber or fiber-free-space coupling. Brightness preserving, low-loss couplings are reliably achievable based on mechanical registration of the reference surfaces, even for single-mode optical fibers and other optical fibers (e.g., large-mode-area optical fibers) where coupling is particularly sensitive to alignment errors. The present fiber connector, as well as the associated connectorized optical-fiber collimators, fiber-to-fiber couplings, and fiber-free-space couplings, are therefore suitable for transport of high-power laser light with brightness preservation. The present fiber connectors may keep losses at a level where active cooling is unnecessary, even for multi-kilowatt average-power levels. Furthermore, it is possible to replace (or de-mate and re-mate) the connectorized optical-fiber collimators in fiber-to-fiber or fiber-free-space couplings without compromising the alignment of the couplings. Connectorized optical-fiber collimators with identically specified reference surfaces are therefore universally interchangeable. This reproducibility of alignment accuracy preserves the convenience of modularity in modular systems. For example, a fiber-coupled laser source may be temporarily disconnected and reconnected, or replaced by another fiber-coupled laser source, with relative ease. In certain embodiments, the reference surfaces are on a glass part such that optics manufacturing techniques may be employed to machine the reference surfaces with optical precision (e.g., sub-visible-wavelength dimensional tolerance).

In one aspect of the invention, a connectorized optical-fiber collimator includes a holder, a bearing, and an optical-fiber collimator. The holder has a frontside, a backside, a through hole, and an outward-facing circumferential surface. The frontside has a planar surface that is orthogonal to a longitudinal axis. The outward-facing circumferential surface surrounds the longitudinal axis and defines a circular circumference that is centered on the longitudinal axis and exists at least in a plane parallel to the planar surface. One of the frontside and backside has a recess on the longitudinal axis. The through hole is on the longitudinal axis and extends from the frontside to the backside. The bearing has a spherical outer surface seated in the recess of the holder such that a center of curvature of the spherical outer surface is on the longitudinal axis. The optical-fiber collimator is seated in a bore through the bearing. Lateral dimensions of the optical-fiber collimator are undersized relative to the bore. The optical-fiber collimator faces in same direction as the frontside and includes an optical fiber and a collimation lens.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIGS. 1 and 2 illustrate a connectorized optical-fiber collimator including an optical-fiber collimator and two connector parts, a disk and a bearing, used to connectorize the optical-fiber collimator, according to an embodiment. The disk has two reference surfaces, a planar surface on the frontside of the disk and a cylindrical surface, configured to facilitate accurate optical alignment of the connectorized fiber collimator in fiber-to-fiber and fiber-free-space couplings based on mechanical registration. The bearing holds the optical-fiber collimator and is seated in a recess in the backside of the disk.

FIG. 3 illustrates a fiber-to-fiber coupling of a pair of the connectorized optical-fiber collimators of FIGS. 1 and 2, according to an embodiment.

FIG. 4 illustrates the use of two rods to co-register cylindrical reference surfaces of connectorized optical-fiber collimators in the fiber-to-fiber coupling of FIG. 3, according to an embodiment.

FIG. 5 illustrates a fiber-to-fiber coupling of a pair of the connectorized optical-fiber collimators of FIGS. 1 and 2, mated to each other by female and male housings, according to an embodiment.

FIGS. 6A-C illustrate a fiber-free-space coupling between a single connectorized optical-fiber collimator and a laser source, according to an embodiment. The connectorized optical-fiber collimator is mounted to a fixture that facilitates alignment between the connectorized optical-fiber collimator and a laser beam delivered by the laser source.

FIG. 7 illustrates a connectorized optical-fiber collimator similar to the connectorized optical-fiber collimator of FIGS. 1 and 2 but with the recess, holding the bearing, formed in the frontside of the disk instead of the backside, according to an embodiment.

FIG. 8 illustrates a connectorized optical-fiber collimator similar to the connectorized optical-fiber collimator of FIG. 7 apart from the bearing protruding beyond the planar surface of the disk, according to an embodiment.

FIG. 9 shows another modification of the connectorized optical-fiber collimator of FIGS. 1 and 2, according to an embodiment. The connectorized fiber collimator of FIG. 9 replaces the disk with a holder having a backside that forms a recess for the bearing.

FIGS. 10A and 10B illustrate a fiber-to-fiber coupling that is similar to the fiber-to-fiber coupling of FIG. 3 except that one of the two connectorized optical-fiber collimators has rounded protrusions on the planar surface.

FIGS. 11A and 11B illustrate another modification of the fiber-to-fiber coupling of FIG. 3, according to an embodiment, wherein the planar surfaces of the two connectorized optical-fiber collimators are spaced apart by three spheres held by a central bracket.

FIGS. 12A and 12B illustrate an embodiment of the connectorized optical-fiber collimator of FIGS. 1 and 2 having one or more reliefs in the frontside of the holder that reduce the area of the planar surface.

FIG. 13 illustrates an embodiment of the connectorized optical-fiber collimator of FIGS. 1 and 2 wherein the frontside has a concave profile such that the planar reference surface takes the shape of a circular line having essentially no radial extent.

FIG. 14 illustrates a connectorized optical-fiber collimator similar to the connectorized optical-fiber collimator of FIGS. 1 and 2 except that the cylindrical surface of the disk is replaced by a less constraining spherical surface, according to an embodiment.

FIG. 15 illustrates another connectorized optical-fiber collimator similar to the connectorized optical-fiber collimator of FIGS. 1 and 2 except that the cylindrical surface of the disk is replaced by a less constraining surface, in this case a conical surface, according to an embodiment.

### DETAILED DESCRIPTION OF THE INVENTION

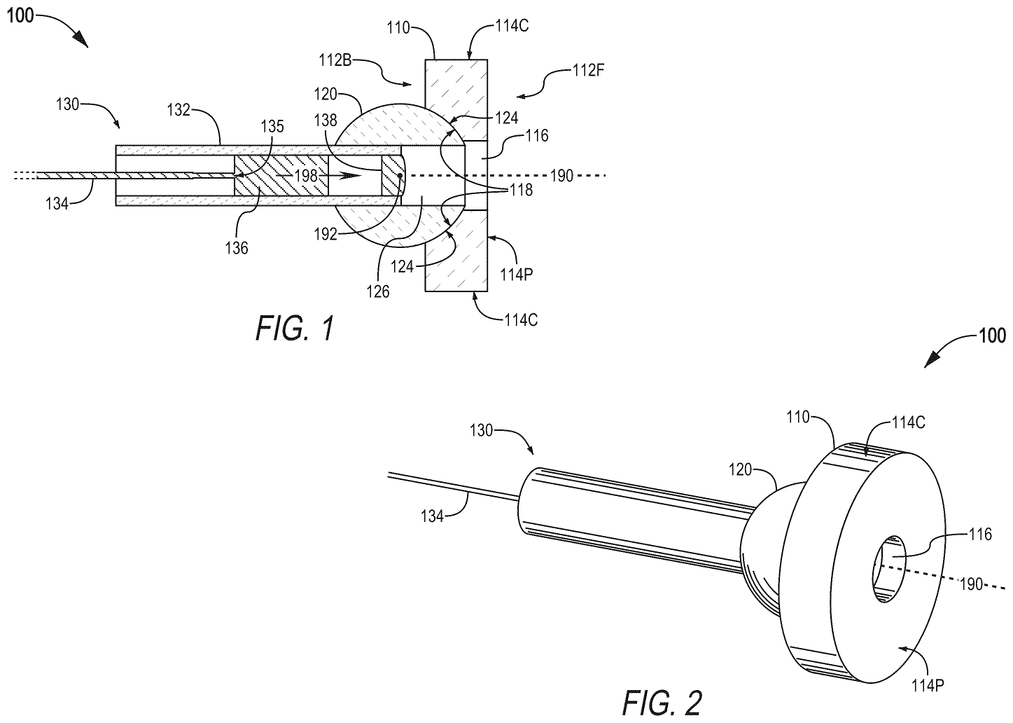

Referring now to the drawings, wherein like components are designated by like numerals, FIGS. 1 and 2 illustrate one connectorized optical-fiber collimator 100 configured to facilitate accurate optical alignment of the connectorized fiber collimator in fiber-to-fiber and fiber-free-space couplings based on mechanical registration of reference surfaces. FIG. 1 is a sectional sideview of connectorized fiber collimator 100, with the section being taken along a plane that contains a longitudinal axis 190. FIG. 2 is a perspective view of connectorized fiber collimator 100. Connectorized fiber collimator 100 includes an optical-fiber collimator 130 and two connector parts, disk 110 and bearing 120, used to connectorize fiber collimator 130.

Fiber collimator 130 includes a collimation lens 138. Collimation lens 138 is configured to at least approximately collimate a laser beam emerging from an end 135 of optical fiber 134 as indicated by arrow 198 (or, conversely, focus an at least approximately collimated laser beam, propagating in the direction opposite arrow 198, onto fiber end 135). In the embodiment depicted in FIGS. 1 and 2, fiber collimator 130 includes a collimator body 132, and optical fiber 134 is terminated in an end cap 136. In this embodiment, end cap 136 is secured in collimator body 132, and collimation lens 138 may be secured in collimator body 132 (as shown in FIG. 1) or to a distal end of collimator body 132. The outer surface of collimator body 132 may be cylindrical. In one implementation, collimator body 132 is a cylinder. Fiber collimator 130 may be of a different form than the one depicted. For example, as compared to the embodiment shown in FIG. 1, collimator body 132 may be omitted and collimation lens 138 instead bonded directly to or integrated with end cap 136. Additionally, end cap 136 may be omitted, for example when optical fiber 134 is a hollow-core optical fiber incompatible with fusing to an end cap.

Disk 110 has a frontside 112F and a backside 112B. Frontside 112F includes a planar surface 114P that is orthogonal to longitudinal axis 190. Planar surface 114P may or may not span the entirety of frontside 112F as shown in FIG. 1. Disk 110 has a cylindrical surface 114C that is centered about longitudinal axis 190, faces radially outward from longitudinal axis 190, and is parallel to longitudinal axis 190. In other words, longitudinal axis 190 is a cylinder axis of cylindrical surface 114C. In this manner, planar surface 114P and cylindrical surface 114C define longitudinal axis 190. Planar surface 114P and cylindrical surface 114C serve as reference surfaces. In other words, each of planar surface 114P and cylindrical surface 114C is a datum that defines a respective reference surface. In a fiber-to-fiber or fiber-free-space coupling, disk 110 functions as a holder that (a) holds fiber collimator 130 via bearing 120 and (b) includes reference surfaces for mechanical registration of connectorized fiber collimator 100.

When disk 110, bearing 120, and fiber collimator 130 are properly positioned relative to each other, an optical axis of fiber collimator 130 is aligned relative to the reference surfaces in such a manner that the optical axis of fiber collimator 130 is identical to longitudinal axis 190. As a result, it is possible to achieve proper alignment of the optical axis of fiber collimator 130 in fiber-to-fiber or fiber-free-space couplings through mechanical registration of the reference surfaces in these couplings. Herein, the “optical axis” of a fiber collimator is identical to optical axis of a laser beam as it emerges from the fiber collimator.

Disk 110 further includes a concave spherical surface 118 that forms a spherical recess in backside 112B. A through hole 116 of disk 110 spans from frontside 112F to backside 112B at the recess formed by spherical surface 118. Both through hole 116 and the recess formed by spherical surface 118 are on longitudinal axis 190, and the center of curvature 192 of spherical surface 118 is on longitudinal axis 190. Disk 110 may have additional features, not depicted in FIGS. 1 and 2, that depart from a typical disk shape.

Bearing 120 couples fiber collimator 130 to disk 110 such that fiber collimator 130 faces in the same direction as frontside 112F. Fiber collimator 130 is seated in a bore 126 through bearing 120. Bearing 120 is seated in the spherical recess of disk 110 formed by spherical surface 118. For that purpose, bearing 120 has a convex spherical surface 124 that matches concave spherical surface 118 of disk 110. The center of curvature of spherical surface 124 coincides with center of curvature 192. Bearing 120 may simply be a sphere penetrated by bore 126, as shown in FIG. 1. Alternatively, bearing 120 has additional features not shown in FIGS. 1 and 2 or may be a truncated sphere penetrated by bore 126. In one embodiment, each of bore 126 and an outer surface of fiber collimator 130 is cylindrical. The lateral dimensions of fiber collimator 130 (i.e., the dimensions approximately orthogonal to the optical axis of fiber collimator 130) are somewhat undersized relative to those of bore 126. For example, when each of bore 126 and the outer surface of fiber collimator 130 is cylindrical, the diameter of bore 126 exceeds the diameter of the outer surface of fiber collimator 130. The difference between these two diameters may be a fraction of a millimeter, e.g., between 20 and 500 micrometers (μm).

Misalignment between the optical axis of fiber collimator 130 and its outer surfaces is difficult to prevent, but the interfaces between bearing 120 and each of fiber collimator 130 and disk 110 provide the degrees of freedom needed to correct for such misalignment. The interface between bearing 120 and disk 110 allows for rotation of bearing 120 about center of curvature 192 of spherical surface 118 to adjust the pointing of the optical axis of fiber collimator 130 relative to longitudinal axis 190. In one scenario, bearing 120 is oriented such that the optical axis of fiber collimator 130 is parallel to longitudinal axis 190. When center of curvature 192 is accurately positioned on longitudinal axis 190, it is possible to adjust pointing of the optical axis of fiber collimator 130 independently of its offset. The lateral undersizing of fiber collimator 130 relative to bore 126 allows for correction of an offset error between the optical axis of fiber collimator 130 and longitudinal axis 190 by laterally translating fiber collimator 130 in bore 126. Once disk 110, bearing 120, and fiber collimator 130 are positioned as desired with respect to each other, adhesives (or other bonding/fixing technique) may be applied to fix the positional relationships between these three parts.

The alignment accuracy of connectorized fiber collimator 100 in a fiber-to-fiber or fiber-free-space coupling depends on the precision of planar surface 114P and cylindrical surface 114C. In one embodiment, disk 110 is made of glass, e.g., fused silica, such that precision optics manufacturing techniques may be employed to form planar surface 114P and cylindrical surface 114C, as well as spherical surface 118. In one embodiment, each of planar surface 114P and cylindrical surface 114C has surface flatness less than 1 μm. (Herein, the surface flatness of a cylindrical surface refers to deviations from the cylindrical profile rather than a planar profile.) It may be possible to relax the surface flatness requirement for cylindrical surface 114C in scenarios where the diameter of the laser beam emerging from, or being coupled into, fiber collimator 130 is substantial. In one example, the surface flatness of cylindrical surface 114C may be up to 160 μm, e.g., between 10 and 160 micrometers. Generally, the required surface flatness depends on the collimated beam diameter, with smaller laser beams requiring better surface flatness than larger laser beams.

Bearing 120 may also be made of glass, which enables the use of precision optics manufacturing techniques to form spherical surface 124, thereby providing a smooth and well-matched interface between bearing 120 and disk 110. Additionally, at least most of fiber collimator 130 may be made of glass, possible exceptions including adhesives and cladding/coating on optical fiber 134 inside fiber collimator 130. For example, collimation lens 138 and collimator body 132, and optional end cap 136, may be made of glass. Implementations where disk 110, bearing, 120, and at least the majority of fiber collimator 130 (as explained above) are made of a similar type of glass, e.g., fused silica, reduce or eliminate any adverse effects that thermal expansion/contraction may have on alignment. One potential source of heat is laser radiation that fails to couple into a receiving optical fiber 134 in a fiber-to-fiber or fiber-free-space coupling. When disk 110, bearing 120, and at least the majority of fiber collimator 130 are made of glass, the transparency of glass helps prevent such lost laser radiation from heating the surfaces of these elements that affect the alignment of connectorized fiber collimator 100 in the coupling.

Spherical surface 118 may be replaced by a conical surface positioned such that a center of curvature of spherical surface 124 of bearing 120 is on longitudinal axis 190. Such a conical surface enables the same rotational adjustment of bearing 120 in the recess of disk 110 as spherical surface 118 and may be simpler to manufacture. Similarly, the recess formed by spherical surface 118 may be replaced by a cylindrical hole in backside 112B of disk 110, optionally with the edge of the cylindrical hole being chamfered. However, especially when bearing 120 and disk 110 are made of glass, the larger interface area achieved with spherical surface 118 reduces wear of spherical surfaces 118 and 124 when bearing 120 is rotated relative to disk 110. Wear of either one of these surfaces generates debris that may settle on critical surfaces, such as the frontside of collimation lens 138 or, possibly less likely, planar surface 114P. Advantageously, neither one of spherical surfaces 118 and 124 interacts directly with the laser beam (whether emerging from or incident on fiber collimator 130), which reduces the risk of debris settling in the laser beam.

FIG. 2 shows cylindrical surface 114C spanning a full 360 degrees about longitudinal axis 190. Alternatively, cylindrical surface 114C may be interrupted in one or more places. For example, a notch in cylindrical surface 114C may be used to indicate a polarization axis and aid polarization alignment in a fiber-to-fiber or fiber-free-space coupling. In a more substantial modification, cylindrical surface 114C is replaced by another surface that circumnavigates longitudinal axis 190 and is, at least in places, parallel to longitudinal axis 190 to provide a suitable reference surface for mechanical registration. The depicted 360-degree cylindrical surface is in many cases the most convenient since it does not impose any constraints on the orientation of disk 110 about longitudinal axis 190 when connectorized fiber collimator 100 is arranged in a fiber-to-fiber or fiber-free-space coupling.

Connectorized optical-fiber collimator 100 may be implemented on a wide range of size scales. In one implementation, the radius of curvature of spherical surface 118 exceeds the lateral dimensions (e.g., diameter) of fiber collimator 130, and the diameter of cylindrical surface 114C is more than double the radius of curvature of spherical surface 118. For example, the lateral dimensions of fiber collimator 130 may be in the range between 2 and 10 millimeters (mm), while the radius of curvature of spherical surface 118 is in the range between 3 and 15 mm and the diameter of cylindrical surface 114C is in the range between 10 and 50 mm.

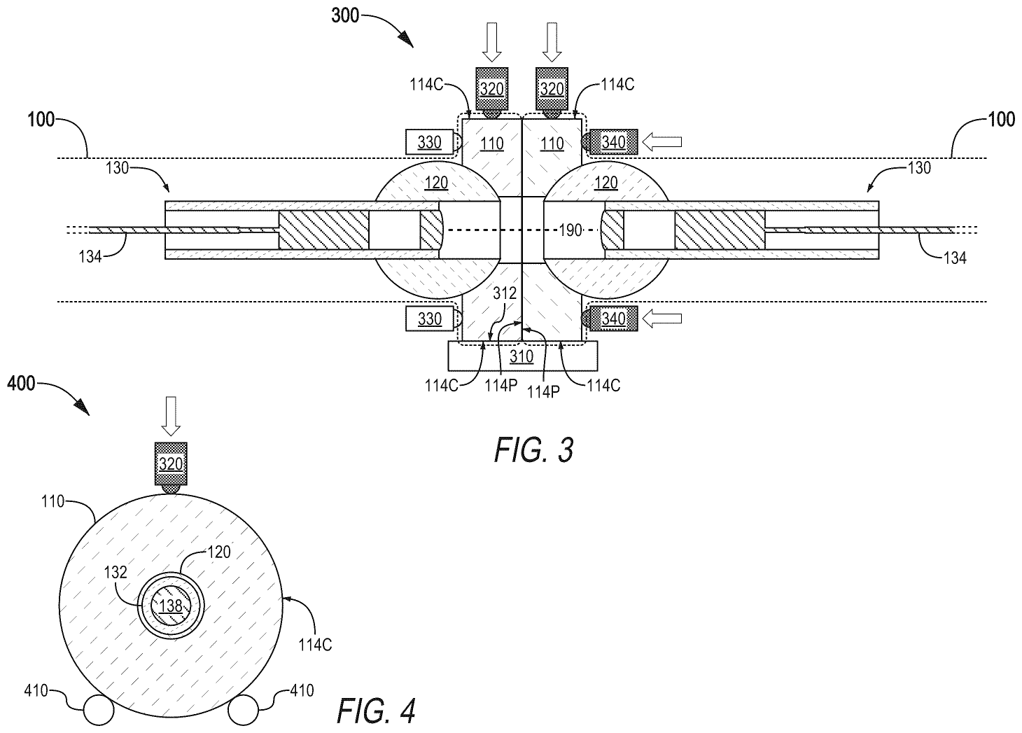

FIG. 3 illustrates, in sectional sideview, one fiber-to-fiber coupling 300 of a pair of connectorized optical-fiber collimators 100. Fiber-to-fiber coupling 300 includes the two connectorized fiber collimators 100 and a registration structure 310 having one or more surfaces 312. The two connectorized fiber collimators 100 may or may not be equipped with identical collimation lenses, and the two corresponding optical fibers 134 may or may not have identical properties. The two connectorized fiber collimators 100 are mechanically registered against each other and against surface 312. More specifically, the two planar surfaces 114P are held against each other such that the two planar surfaces 114P are parallel, and both cylindrical surfaces 114C are held against surface 312 such that the two cylindrical surfaces 114C are concentric. This arrangement ensures that the longitudinal axes 190 of the two connectorized fiber collimators 100, respectively, are identical. In other words, the two connectorized fiber collimators 100 share a common longitudinal axis 190. As a result, the optical axes of the two fiber collimators 130 coincide when each connectorized fiber collimator 100 is aligned such that the optical axis of its fiber collimator 130 is identical to its longitudinal axis 190, as discussed above in reference to FIGS. 1 and 2. Planar surfaces 114P may be held directly against each other, as shown in FIG. 3, or in indirect contact with each other via, e.g., one or more planar substrates positioned between planar surfaces 114P. Such planar substrates may be interferometrically planar.

Registration structure 310 may include two or more separate registration elements, e.g., substrates or rods, positioned at different respective locations along the circumference of the concentric cylindrical surfaces 114C. Preferably, registration structure 310 contacts cylindrical surfaces 114C at exactly two locations along their circumference so as to fully determine but not over-constrain their positions.

Fiber-to-fiber coupling 300 may include clamping mechanisms that press planar surfaces 114P against each other and press cylindrical surfaces 114C against surface(s) 312 of registration structure 310. In the example depicted in FIG. 3, fiber-to-fiber coupling 300 includes two actuators 320, at least one actuator 340, and one or more stops 330. Each actuator 320 applies a pressure on cylindrical surface 114C of a respective disk 110 in the direction towards registration structure 310. The two actuators 320 may be two respective portions of a single common actuator. Actuator(s) 340 apply a pressure to the backside of a first one of disks 110, to press the pair of disks 110 against stops(s) 330 in contact with the backside of the second disk 110. Although not shown, stops(s) 330 may be a second instance of actuator(s) 340 pressing against the backside of the second disk 110. Actuators 320 and 340, and also actuator-implementations of stop(s) 330, may be spring-loaded mechanisms implemented in external housings not shown in FIG. 3.

FIG. 4 is a sectional view of one fiber-to-fiber coupling 400 corresponding to an embodiment of fiber-to-fiber coupling 300 wherein registration structure 310 is implemented as two parallel rods 410. The section of FIG. 4 is taken orthogonally to longitudinal axis 190 through one of disks 110. Each rod 410 may be cylindrical. The pair of rods 410 provide sufficient registration to fully define the lateral positions of disks 110 without over-constraining these positions. Rods 410 may be made of sapphire, stainless steel, fused silica, or alumina, and may be manufactured with high precision.

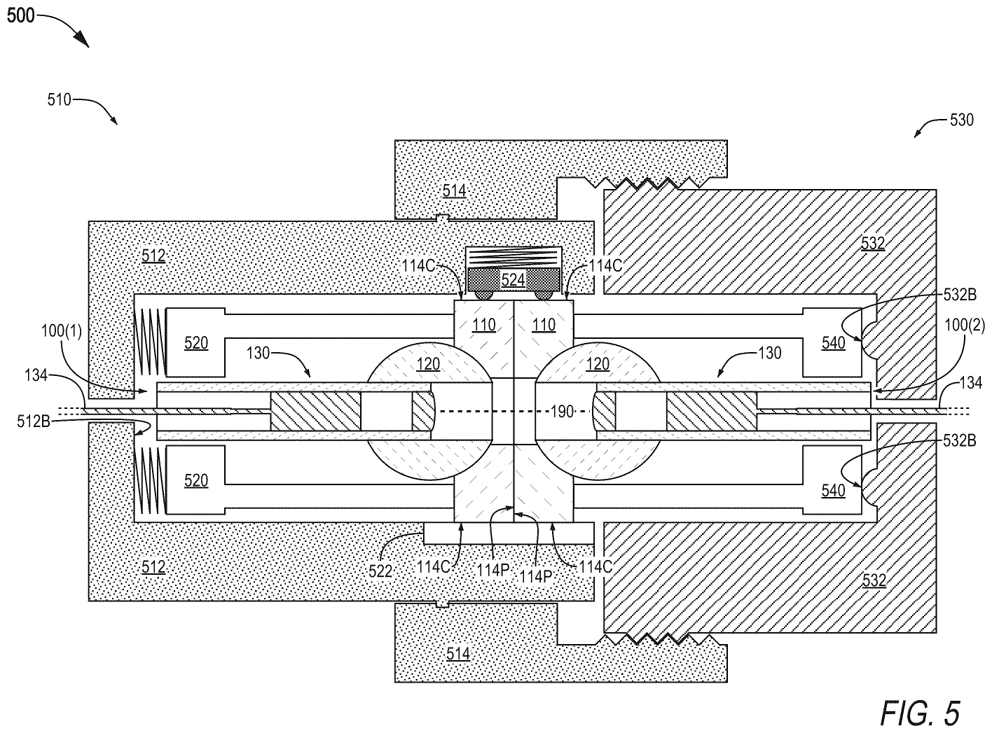

FIG. 5 is a cross-sectional sideview of one fiber-to-fiber coupling 500 of a pair of connectorized optical-fiber collimators 100, mated to each other by female and male housings. Fiber-to-fiber coupling 500 is an embodiment of fiber-to-fiber coupling 300. One connectorized fiber collimator 100(1), shown to the left in FIG. 5, is fitted with a female housing 510, and the other connectorized fiber collimator 100(2), shown to the right in FIG. 5, is fitted with a male housing 530. Male housing 530 includes an externally threaded sleeve 532. Female housing 510 includes a sleeve 512 and an internally threaded ring 514 coupled to sleeve 512. Internally threaded ring 514 is configured to be threaded onto externally threaded sleeve 532.

Female housing 510 further includes a longitudinal spacer 520 between disk 110 of connectorized fiber collimator 100(1) and a bottom surface 512B of sleeve 512. Similarly, male housing 530 includes a longitudinal spacer 540 between disk 110 of connectorized fiber collimator 100(2) and a bottom surface 532B of threaded sleeve 532. In the depicted example, spacer 520 is spring-loaded while spacer 540 is rigid. Alternatively, both of spacers 520 and 540 may be spring-loaded, e.g., such that there are springs between bottom surface 532B and spacer 540, or spacer 540 may be spring-loaded while spacer 520 is rigid. Female housing 510 also includes a lateral clamping mechanism formed by a registration structure 522 and a spring-loaded actuator 524. Registration structure 522 is an embodiment of registration structure 310 and may be implemented as rods 410. Spring-loaded actuator 524 is an embodiment of actuators 320.

To couple the two connectorized optical-fiber collimators 100 to each other, internally threaded ring 514 is threaded onto externally threaded sleeve 532 either before or after contacting planar surfaces 114P of disks 110 to each other. Internally threaded ring 514 is threaded sufficiently far onto externally threaded sleeve 532 that disks 110 are pressed against each other by sleeves 512 and 532 via spacers 520 and 540. This operation results in the two planar surfaces 114P being parallel, as well as disks 110 being clamped laterally between spring-loaded actuator 524 and registration structure 522. The interface between registration structure 522 and cylindrical surfaces 114C of disks 110 thereby ensures that the two cylindrical surfaces 114C are concentric.

Fiber-to-fiber coupling 500 is only one of many possible embodiments of fiber-to-fiber coupling 300 based on female/male housing pairings. In another class of embodiments, the housings are androgynous, and a central alignment sleeve placed between the two housings contains registration structure 310 and actuators 320.

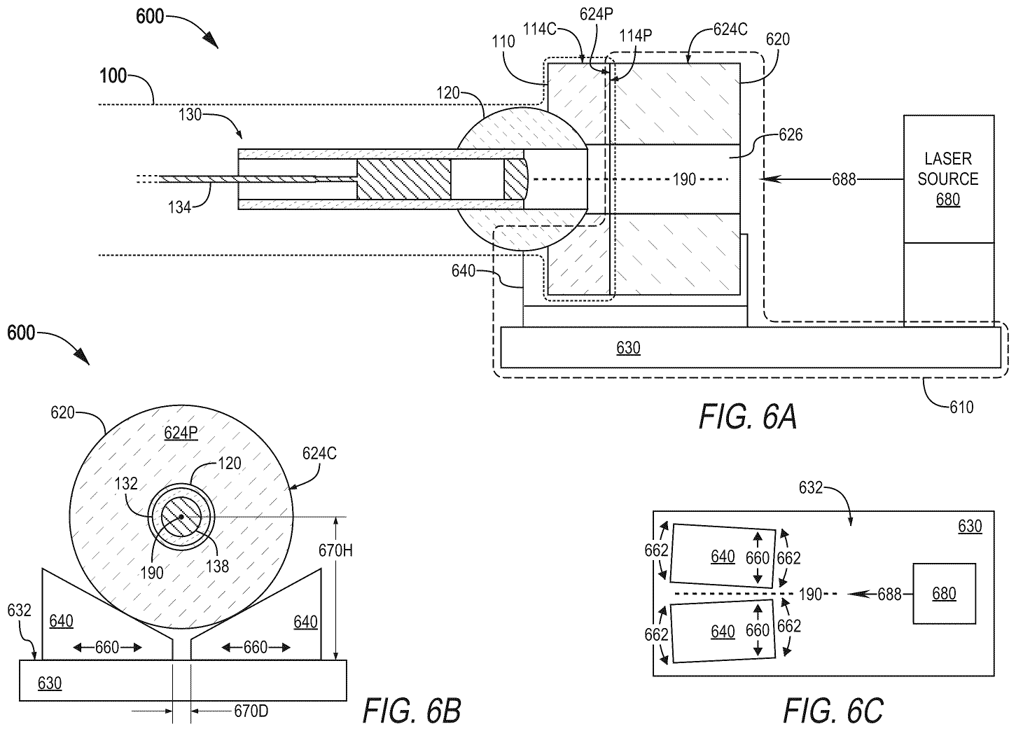

FIGS. 6A-C illustrate one fiber-free-space coupling 600 between a single connectorized optical-fiber collimator 100 and a laser source 680. FIG. 6A is a sectional sideview of fiber-free-space coupling 600, with the section being taken along a plane that contains a longitudinal axis 190 of connectorized optical-fiber collimator 100. FIG. 6B is a frontal view of fiber-free-space coupling 600 as viewed from laser source 680. FIG. 6C is a top view of selected elements of fiber-free-space coupling 600 showing exemplary degrees of freedom for alignment.

Fiber-free-space coupling 600 includes connectorized fiber collimator 100 and a fixture 610. Connectorized fiber collimator 100 is mounted to fixture 610. Fixture 610 facilitates alignment between connectorized fiber collimator 100 and a laser beam 688 delivered by laser source 680. Fixture 610 includes a base 630. Laser source 680 is coupled to base 630. Fixture 610 also includes a pair of wedges 640 supported by base 630 and forming an adjustable v-groove, and a cylindrical block 620 seated in the v-groove. Cylindrical block 620 has a planar surface 624P and a cylindrical surface 624C. Cylindrical surface 624C has the same diameter as cylindrical surface 114C of disk 110. Cylindrical block 620 also has a through hole 626, on and along longitudinal axis 190, that allows passage of laser beam 688 to connectorized fiber collimator 100. (Although not shown, cylindrical block 620 may have additional features that depart from the cylindrical shape, and cylindrical surface 624C may be interrupted.) Disk 110 and cylindrical block 620 are seated together in the v-groove formed by wedges 640, such that cylindrical surfaces 114C and 624C are concentric, and planar surfaces 114P and 624P are parallel. In this configuration, the cylinder axis of cylindrical block 620 is identical to longitudinal axis 190 of connectorized fiber collimator 100.

As shown in FIG. 6B, the pair of wedges 640 may be adjusted to translate longitudinal axis 190 both in the transverse dimension parallel to the support surface of base 630 and in the orthogonal transverse dimension. The distance 670D between wedges 640 defines the height 670H of longitudinal axis 190 above base 630. Distance 670D may be adjustable by translating one or both of wedges 640, as indicated by respective arrows 660. Fixture 610 may be implemented with both of wedges 640 or only a single one of wedges 640 being translatable relative to base 630.

FIG. 6C is a top view of base 630 showing exemplary positions of laser source 680 and wedges 640. In addition to being translatable as indicated by arrows 662, wedges 640 may be rotatable in the plane parallel to the supporting surface 632 of base 630. Such rotation allows for adjustment of the angle between longitudinal axis 190 and supporting surface 632, in the event that laser beam 688 does not propagate in a plane parallel to the supporting surface 632.

In one scenario, fixture 610 is adjusted, as discussed above, such that longitudinal axis 190 is identical to the optical axis of laser beam 688. This may be checked by evaluating the coupling efficiency of laser beam 688 into optical fiber 134 when (a) connectorized fiber collimator 100 is seated in the v-groove as discussed above and (b) the optical axis of fiber collimator 130 is aligned with longitudinal axis 190 of connectorized fiber collimator 100. Once fixture 610 is adjusted to coincide longitudinal axis 190 with the optical axis of laser beam 688, the positions of wedges 640 and cylindrical block 620 are fixed, for example using adhesives or using clamping mechanism similar to those discussed above in reference to FIG. 3. Disk 110 of connectorized fiber collimator 100 may also be fixed to cylindrical block 620 and/or wedges 640 in a permanent or removable fashion. When this initial connectorized fiber collimator 100, used to align fixture 610, is removably coupled to cylindrical block 620 and wedges 640, this initial connectorized fiber collimator 100 may be replaced with a second, similar connectorized fiber collimator 100 aligned such that the optical axis of its fiber collimator 130 is identical to its longitudinal axis 190. By virtue of the fixed position of cylindrical block 620, no other alignment is required to ensure optimal coupling efficiency of laser beam 688 into this second connectorized fiber collimator 100.

Laser sources 680, as well as other optical modules, generating an output laser beam that is intended to be coupled into an optical fiber, may be equipped with a fixture 610. In such systems, fixture 610 may have been pre-aligned with a temporary connectorized fiber collimator 100, since removed from fixture 610. Fiber-free-space coupling 600 may also be used to couple a laser beam from connectorized fiber collimator 100 to an optical system. Systems configured to receive a laser beam from connectorized fiber collimator 100 may be equipped with fixture 610 ready to accept connectorized fiber collimator 100. Also in this case, fixture 610 may have been pre-aligned with a temporary connectorized fiber collimator 100, since removed from fixture 610.

Wedges 640 may be modified to take on a different shape. For example, a pair of rods similar to rods 410 of FIG. 4 may provide the same functionality as wedges 640 in terms of supporting cylindrical block 620 and disk 110. The wedge shape may, however, lend itself better to translation/rotation along surface 632 of base 630. A pair of quarter-rods may be a suitable alternative to wedges 640 since a quarter rod provides two orthogonal planar surfaces: one planar surface for interfacing with surface 632 and another planar surface that may be used to manipulate the position of the quarter rod.

In implementations where laser source 680 has functionality for adjusting the propagation direction of laser beam 688, fixture 610 may be modified to be rigid, i.e., non-adjustable. In such modifications, fixture may include base 630, cylindrical block 620, and a v-groove that supports cylindrical block 620 on base 630.

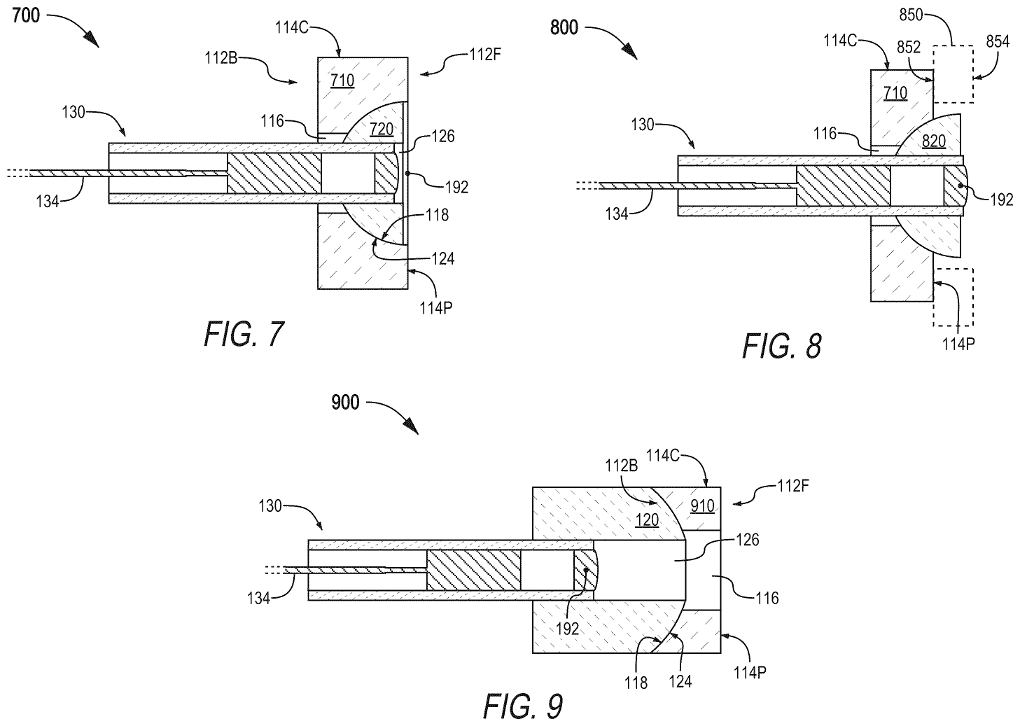

FIGS. 7-9 illustrate several exemplary modifications of connectorized optic-fiber collimator 100 that may be implemented in fiber-to-fiber coupling 300 and fiber-free-space coupling 600 with little or no adaptation required.

FIG. 7 shows one connectorized optical-fiber collimator 700 similar to connectorized optical-fiber collimator 100 but with the recess formed in the frontside of the disk instead of the backside. Connectorized fiber collimator 700 replaces disk 110 and bearing 120 with a disk 710 and a bearing 720, respectively. Disk 710 is similar to disk 110 apart from the recess, formed by spherical surface 118, being in frontside 112F instead of backside 112B. In order to prevent bearing 720 from protruding beyond planar surface 114P, bearing 720 is of a more truncated shape than a sphere, for example a half-sphere penetrated by bore 126 (bore 126 is not visible in FIG. 7 due to fiber collimator 130 passing therethrough). As shown in FIG. 7, the front end of fiber collimator 130 may be between frontside 112F and backside 112B, such that fiber collimator 130 also does not protrude beyond planar surface 114P.

FIG. 8 shows one connectorized optical-fiber collimator 800 similar to connectorized optical-fiber collimator 700 apart from the bearing protruding beyond planar surface 114P. In one embodiment, bearing 820 of connectorized fiber collimator 800 is identical to bearing 720 of connectorized fiber collimator 700, but the thickness of disk 710 is reduced in connectorized fiber collimator 800, resulting in bearing 820 protruding beyond planar surface 114P. In another embodiment, bearing 820 is larger or of a different shape than bearing 720. Bearing 820 may be a sphere penetrated by bore 126 (bore 126 is not visible in FIG. 8 due to fiber collimator 130 passing therethrough).

The axial footprint of bearing 820 onto planar surface 114P (that is, the projection of bearing 820 onto planar surface 114P along a projection direction orthogonal to planar surface 114P) is surrounded by at least a portion of planar surface 114P. This radially-outermost portion of planar surface 114P may therefore still be used for registration in a fiber-to-fiber or fiber-free-space coupling.

Connectorized fiber collimator 800 may include a spacer 850, e.g., a ring with opposite planar surfaces 852 and 854. Spacer 850 may be bonded to planar surface 114P. Spacer 850 allows for implementation in fiber-to-fiber coupling 300 together with another connectorized fiber collimator 800 that does or does not include its own spacer 850. Alternatively, a single spacer 850 may be implemented in fiber-to-fiber coupling 300 between two connectorized fiber collimators 800 not already equipped with spacer 850. Spacer 850 may also aid implementation of connectorized fiber collimator 800 in fiber-free-space coupling 600, in the event that through hole 626 of cylindrical block 620 cannot accommodate the portion of bearing 820 protruding beyond planar surface 114P.

FIG. 9 shows another connectorized optical-fiber collimator 900 that is similar to connectorized optical-fiber collimator 100. As compared to connectorized fiber collimator 100, connectorized fiber collimator 900 replaces disk 110 with a holder 910 that is similar to disk 110 except for spherical surface 118 forming the entire backside 112B of holder 910 (apart from through hole 116).

Referring again to fiber-to-fiber coupling 300 of FIG. 3, direct contact between planar surfaces 114P of the two connectorized fiber collimators 100 may, under certain circumstances, result in planar surfaces 114P bonding to each other by optical contacting. As discussed above, it is generally advantageous for the performance of fiber-to-fiber coupling 300 that planar surfaces 114P are high-precision glass surfaces with excellent flatness. When such high-quality, planar glass surfaces are contacted to each other and further subjected to both (a) direct pressure from clamping between stop(s) 330 and actuators 340 and (b) possible shear stress if actuators 320 forces the planar glass surfaces to slide relative to each other, inadvertent optical contacting may occur. Optical contacting between the two planar glass surfaces makes it impossible (or at least difficult) to disconnect connectorized fiber collimators 100 from each other.

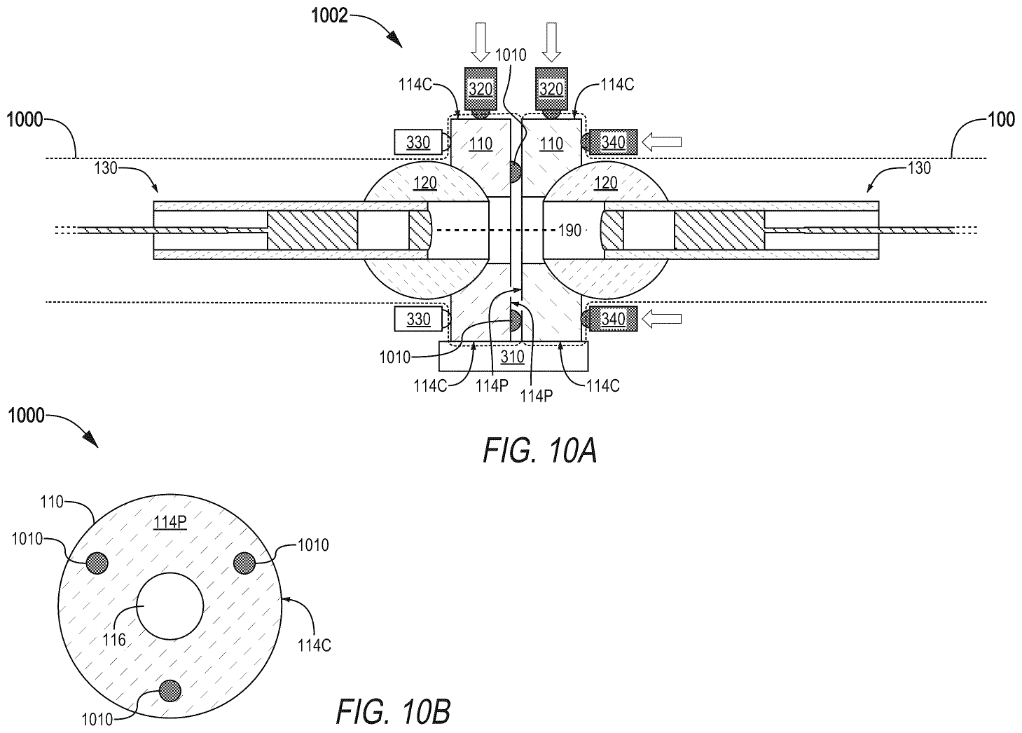

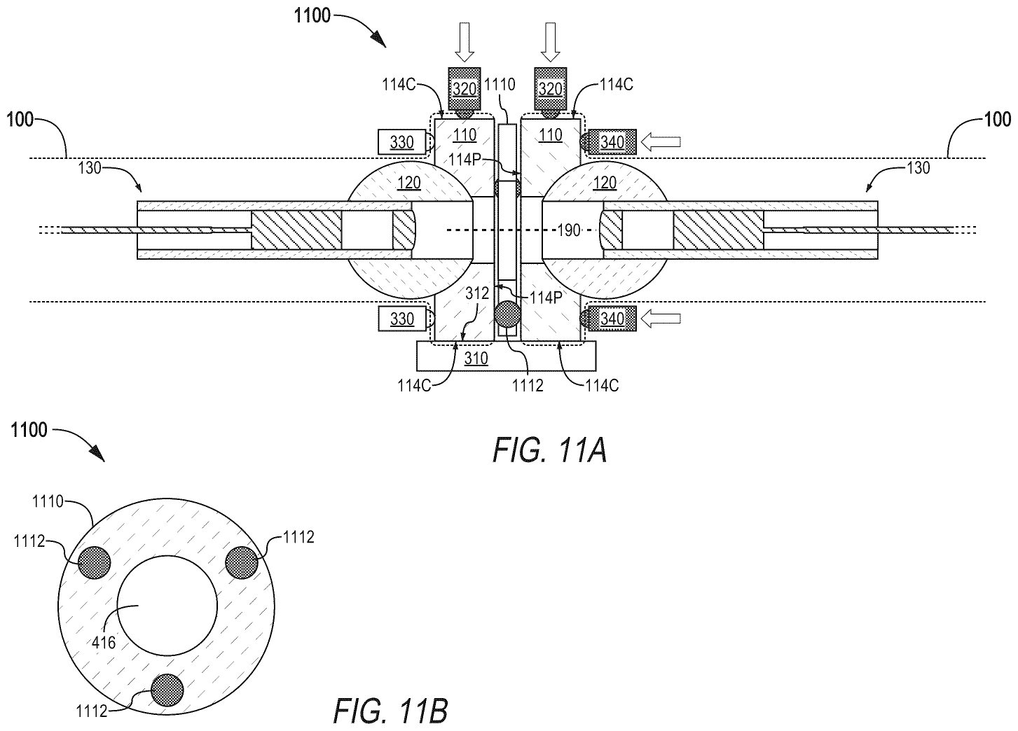

Optical contacting may be prevented by modifying the interface between the two planar glass surfaces. The two planar glass surfaces may be chemically treated to reduce the risk of optical contacting. Applicable chemical treatments include etching, plasma treatment to reduce surface energies, and a coating.] Such treatment may or may not last through several or many disconnect and reconnect operations. A mechanical solution may be more durable. Two different mechanical solutions are presented below in reference to FIGS. 10A-11B.

FIGS. 10A and 10B illustrate one fiber-to-fiber coupling 1002 that is similar to fiber-to-fiber coupling 300 except that one of the two connectorized fiber collimators 100 is replaced by a connectorized fiber collimator 1000 with rounded protrusions from the planar surface. FIG. 10A is a sectional sideview of fiber-to-fiber coupling 1002, and FIG. 10B is a front view of connectorized fiber collimator 1000. Connectorized fiber collimator 1000 is similar to connectorized fiber collimator 100 but further includes three rounded protrusions 1010 on planar surface 114P. Protrusions 1010 may be integrally formed with disk 110. However, for the purpose of manufacturing planar surface 114P with high precision while also ensuring that each protrusion has the same height orthogonally to planar surface 114P, it may be advantageous to manufacture protrusions 1010 separately from planar surface 114P and then bond protrusions 1010 to planar surface 114P. Alternatively, protrusions 1010 may be coated unto planar surface 114P. Preferably, connectorized fiber collimator 1000 has exactly three protrusions 1010 such that, even if the heights of protrusions 1010 orthogonally to planar surface 114P are not exactly identical, protrusions 1010 still define a plane. Protrusions 1010 may be half-spheres, and may be made of glass. The roundedness of protrusions 1010 reduces the interface between the two connectorized fiber collimators to three local contact areas that are essentially point-contacts. Point contacts are unlikely to undergo irrevocable optical contacting.

Fiber-to-fiber coupling 1002 may be modified to couple two connectorized fiber collimators 1000, each including protrusions 1010. In one such modification, fiber-to-fiber coupling 1002 further includes a central spacer between the two connectorized fiber collimators 1000. This central spacer is clamped between the protrusions 1010 of one connectorized fiber collimator 1000 on one side and the protrusions 1010 of the other connectorized fiber collimator 1000 on the other side. The two surfaces of the central spacer in contact with the connectorized fiber collimators 1000 are flat and parallel to high precision.

FIGS. 11A and 11B illustrate another fiber-to-fiber coupling 1100 with round objects at the interface between planar surfaces 114P of the two connectorized fiber collimators 100. Fiber-to-fiber coupling 1100 is similar to fiber-to-fiber coupling 300 except for further including a central bracket 1110 holding three identical spheres 1112. FIG. 11A is a sectional sideview of fiber-to-fiber coupling 1100, and FIG. 11B is a front view of bracket 1110. Bracket 1110 is positioned between planar surfaces 114P, such that the three spheres 1112 function as spacers between planar surfaces 114P, that is, each sphere 1112 spans between planar surfaces 114P. As in fiber-to-fiber coupling 1002, the interface between planar surfaces 114P is reduced to three local contact areas, essentially point contacts, thereby preventing optical contacting. Spheres 1112 may be rigidly held by bracket 1110. For example, spheres 1112 may be fused with or otherwise bonded to bracket. Alternatively, bracket 1110 may hold spheres 1112 loosely. Spheres 1112 may be made of glass. Precisely manufactured glass spheres 1112 with very tight tolerances are commercially available. Glass spheres 1112 may have a diameter in the range between 0.5 and 10 mm.

Bracket 1110 may be implemented in a central alignment sleeve between connectorized fiber collimators 100. Two identical connectorized fiber collimators 100 (with no interfering protrusions from planar surfaces 114P) can be mated in fiber-to-fiber coupling 1100. As compared to fiber-to-fiber coupling 1002, fiber-to-fiber coupling 1100 reduces the complexity of the connectorized fiber collimators by shifting the burden to a central bracket.

Fiber-free-space coupling 600 may similarly suffer from optical contacting between planar surface 114P of connectorized fiber collimator 100 and planar surface 624P of cylindrical block 620. This issue may be remedied using similar techniques as discussed above for fiber-to-fiber couplings, for example with rounded protrusions 1010 on one of planar surfaces 114P and 624P, or with bracket 1110 and spheres 1112 between planar surfaces 114P and 624P.

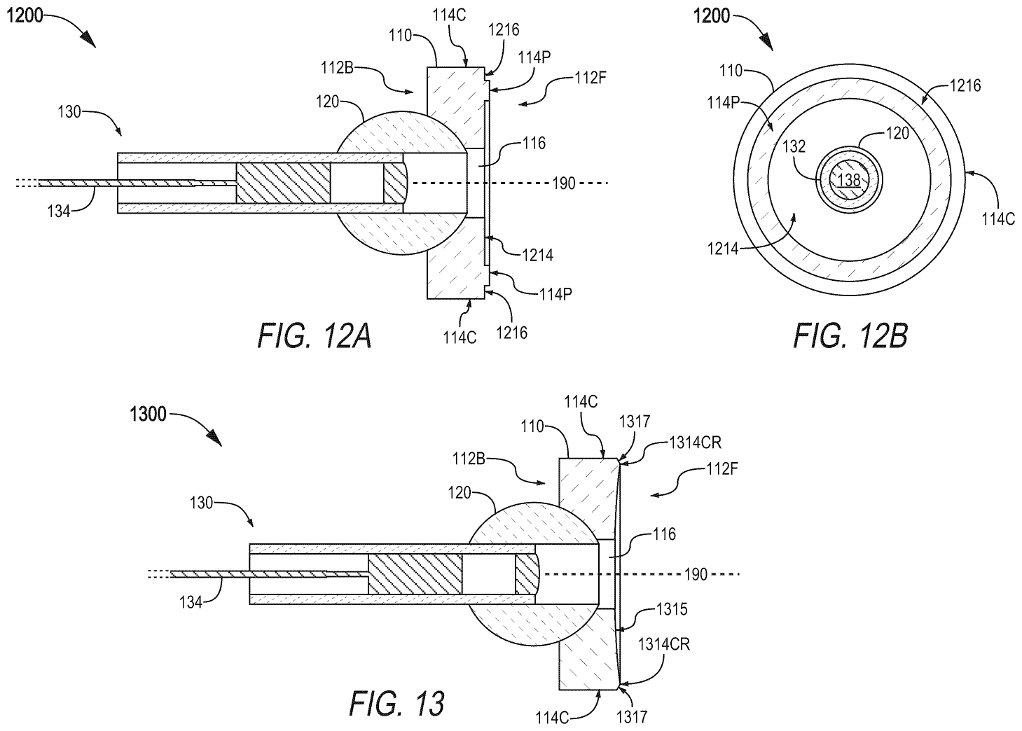

Referring again to FIG. 1, planar surface 114P does not necessarily constitute the entire front surface of disk 110. Reduction of the area of planar surface 114P may help prevent optical contacting between planar surface 114P and its mating surface in fiber-to-fiber and fiber-free-space couplings. Exemplary embodiments of connectorized fiber collimator 100, with a reduced area of planar surface 114P, are discussed below in reference to FIGS. 12A, 12B and 13.

FIGS. 12A and 12B illustrate one connectorized optical-fiber collimator 1200, which is an embodiment of connectorized optical-fiber collimator 100 having one or more reliefs in frontside 112F that reduce the area of planar surface 114P. FIG. 12A is a sectional sideview of connectorized fiber collimator 1200 with the section being taken along a plane that contains longitudinal axis 190. FIG. 12B is a front view of connectorized fiber collimator 1200 showing the reduced area of planar surface 114P in this embodiment. Frontside 112F has one or both of reliefs 1214 and 1216, each of which is a surface that is recessed from planar surface 114P. Relief 1214 extends from through hole 116 to planar surface 114P. Relief 1216 extends from planar surface 114P to the radially-outermost edge of frontside 112F. Connectorized fiber collimator 1200 may further include rounded protrusions 1010 on planar surface 114P or be used in conjunction with bracket 1110 and spheres 1112.

FIG. 13 is a sectional sideview of one connectorized optical-fiber collimator 1300, which is an embodiment of connectorized optical-fiber collimator 100 wherein frontside 112F has a concave profile such that the frontside planar surface 114P takes the shape of a circular line 1314CR having essentially no radial extent. Frontside 112F of connectorized fiber collimator 1300 has a concave surface 1315. The curvature of concave surface 1315 may be spherical. Concave surface 1315 terminates in a circular edge forming circular line 1314CR. Circular line 1314CR may coincide with an edge between concave surface 1315 and cylindrical surface 114C. Optionally, to render circular line 1314CR less brittle, the edge between concave surface 1315 and cylindrical surface 114C may have a chamfer 1317, as depicted in FIG. 13. Circular line 1314CR is contained in a plane and thus forms a planar reference surface despite having essentially no radial extent. Circular line 1314C may be viewed as a planar datum that defines the planar reference surfaces. Concave surface 1315 may be significantly less concave than spherical surface 118. For example, when concave surface 1315 is spherical, its radius of curvature may be one or several orders of magnitude greater than the radius of curvature of spherical surface 118.

Referring again to FIG. 1, it may be advantageous to replace cylindrical surface 114C of connectorized fiber collimator 100 with a less constraining surface. In fiber-to-fiber and fiber-free-space couplings, one constraint is imposed by registration of planar surface 114P against its mating surface (e.g., planar surface 114P of another connectorized fiber collimator 100 or planar surface 624P of cylindrical block 620), and another constraint is imposed by registration of cylindrical surface 114C against its mating surfaces (e.g., registration structure 310 or wedges 640). These two constraints may be conflicting if planar surface 114P and cylindrical surface 114C are not orthogonal to each other, for example due to manufacturing tolerances.

Non-orthogonality between planar surface 114P and cylindrical surface 114C is not necessarily detrimental to the performance of the associated fiber-to-fiber and fiber-free-space couplings. In one mitigation scheme, cylindrical surface 114C is truncated to have a relatively short extent in the longitudinal direction, thereby limiting the impact of potential conflicting constraints. Another mitigation scheme takes advantage of a relative insensitivity to offset error, in fiber-to-fiber and fiber-free-space couplings, in certain scenarios. In these scenarios, the collimated beam diameter is sufficiently large that the fiber-to-fiber and fiber-free-space couplings are significantly less sensitive to offset error than pointing error. The impact on non-orthogonality on performance may then be reduced by applying a greater clamping force in the longitudinal direction than in the radial direction. The greater longitudinal clamping force favors registration of planar surface 114P, and thus pointing accuracy, over registration of cylindrical surface 114C and offset elimination. However, a large longitudinal clamping force may increase the risk of optical contacting in some situations. It may be preferable to instead replace cylindrical surface 114C with a surface that does not constrain the pointing direction of planar surface 114P.

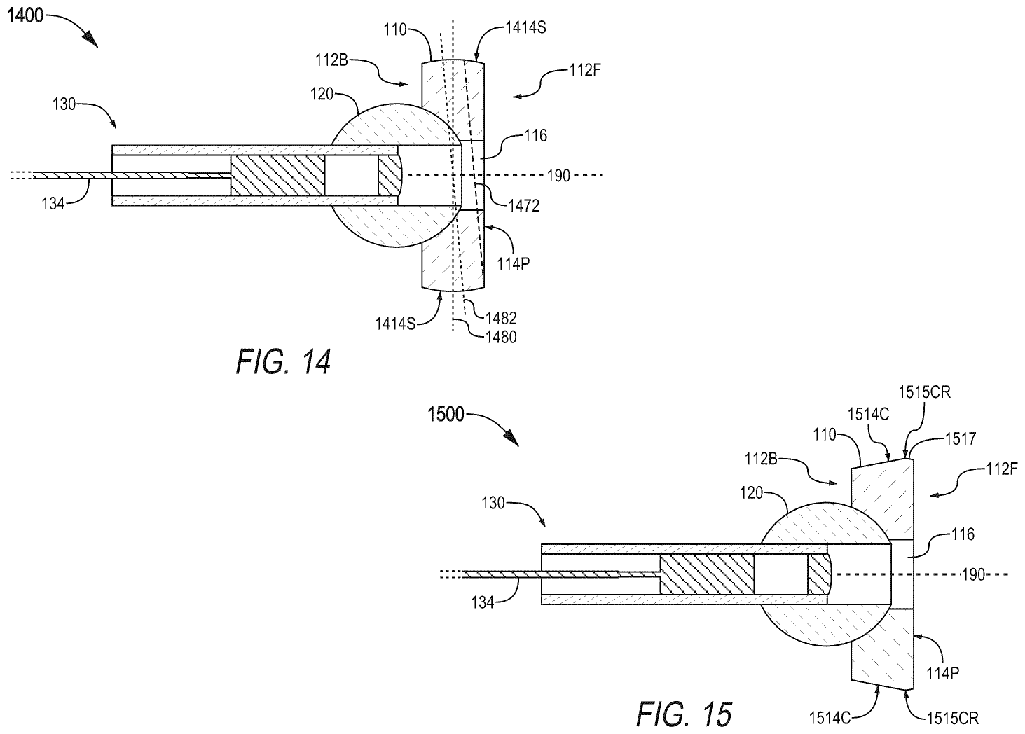

FIG. 14 illustrates one connectorized optical-fiber collimator 1400 similar to connectorized optical-fiber collimator 100 except that cylindrical surface 114C is replaced by a less constraining spherical surface 1414S. Spherical surface 1414S defines a circular reference circumference of disk 110 that performs the same radial registration function as cylindrical surface 114C in fiber-to-fiber and fiber-free-space couplings, except without restricting the orientation of planar surface 114P. In connectorized optical-fiber collimator 1400, longitudinal axis 190 is the axis that is orthogonal to planar surface 114P and passes through the center of curvature of spherical surface 1414S.

Spherical surface 1414S provides a circular reference circumference of the same size for a range of orientations of planar surface 114P. More specifically, the orientation of the circular reference circumference depends on the orientation of planar surface 114P, but the radius of the circular reference circumference is the same regardless of the orientation of planar surface 114P. For any given pointing direction of planar surface 114P, the circular reference circumference is parallel to planar surface 114P and centered on the center of curvature of spherical surface 1414S. Two examples are depicted in FIG. 14. Line 1480 indicates the orientation of the circular reference circumference when planar surface 114 is oriented as drawn in FIG. 14. Line 1482 indicates the orientation of the circular reference circumference if planar surface 114 instead is oriented as indicated by line 1472. The spherical shape of spherical surface 1414S ensures that the circular reference circumference has the same radius for each of these orientations of planar surface 114P. Additionally, regardless of the exact orientation of planar surface 114P, contact areas between spherical surface 1414S and radial registration surfaces (e.g., registration structure 310 or wedges 640) are limited to the circular reference circumference. Spherical surface 1414S thereby eliminates the potential of conflicting constraints between longitudinal and radial registration.

FIG. 15 illustrates one connectorized optical-fiber collimator 1500 similar to connectorized optical-fiber collimator 100 except that cylindrical surface 114C is replaced by a less constraining conical surface 1514C. The transverse dimension of conical surface 1514C, orthogonally to longitudinal axis 190, increases in the direction toward planar surface 114P. Conical surface 1514C may extend all the way to planar surface 114P, optionally with a chamfer 1517 at the edge between conical surface 1514C and planar surface 114P. The foreword-most edge of conical surface 1514C is in the form of a circular line 1515CR having essentially no longitudinal extent. Optional chamfer 1517 helps reduce the brittleness of the edge defining circular line 1515CR. Planar surface 114P and circular line 1515CR cooperate to define longitudinal axis 190 such that circular line 1515CR is centered about longitudinal axis 190.

Circular line 1515CR provides a circular reference circumference for radial registration of disk 110 in fiber-to-fiber and fiber-free-space couplings. Due to the (essentially) zero longitudinal extent of circular line 1515CR, the constraint imposed by registration of circular line 1515CR does not conflict with the constraint imposed by registration of planar surface 114P, even if the orientation of planar surface 114P deviates from its nominal orientation. Unlike in connectorized fiber collimator 1400, an error in the pointing direction of planar surface 114P in connectorized fiber collimator 1500 may result in an offset error in fiber-to-fiber and fiber-free-space couplings. However, as mentioned above, the performance of the present fiber-to-fiber and fiber-free-space couplings is relatively insensitive to offset error in scenarios where the collimated beam diameter is relatively large. Furthermore, conical surface 1514C may be simpler to manufacture than spherical surface 1414S.

Without departing from the scope hereof, the shape of conical surface 1514C may be longitudinally flipped, such that its radius increases in the direction away from planar surface 114P, and/or chamfer 1517 may be enlarged. In either case, the position of circular line 1515CR will be farther from planar surface 114P than depicted in FIG. 15. While this may be a viable option in some scenarios, positioning of circular line 1515CR close to planar surface 114P is preferable for limiting the potential offset errors discussed above.

The modifications of connectorized optical-fiber collimator 100 discussed above in reference to FIGS. 14 and 15 may be implemented also in the embodiments discussed above in reference to FIGS. 12A, 12B, and 13. More generally, a forward-most portion of disk 110 defines a planar reference surface for longitudinal registration, and an outward-facing circumferential surface of disk 110 surrounds longitudinal axis 190 and defines a circular reference circumference for radial registration. The planar reference surface may or may not have any radial extent. The portion of the outward-facing circumferential surface defining the circular reference circumference may or may not have any longitudinal extent. The circular reference circumference is centered on longitudinal axis 190 and exists at least in a plane that is parallel to the planar reference surface.

The portion of the outward-facing circumferential surface, defining the circular reference circular circumference, may coincide with the entire reference circumference or have recesses and/or other interruptions at certain locations along the circular reference circumference. In some scenarios, it is preferable that this portion of the outward-facing circumferential surface coincides with the entire circular reference circumference because the connectorized optical-fiber collimator may then be implemented in fiber-to-fiber and fiber-free-space couplings at any orientation about longitudinal axis 190. On the other hand, for polarization-sensitive embodiments of optical fiber 134, it may be advantageous to have at least one notch, flat, or protrusion in the outward-facing circumferential surface to ensure that the connectorized optical-fiber collimator is necessarily seated in fiber-to-fiber or fiber-free-space couplings at a particular orientation about longitudinal axis 190.

The present invention is described above in terms of a preferred embodiment and other embodiments. The invention is not limited, however, to the embodiments described and depicted herein. Rather, the invention is limited only by the claims appended hereto.

What is claimed is:

1. A connectorized optical-fiber collimator, comprising:
a holder having a frontside, a backside, a through hole, and an outward-facing circumferential surface, the frontside having a planar surface that is orthogonal to a longitudinal axis, the outward-facing circumferential surface surrounding the longitudinal axis and defining a circular circumference that is centered on the longitudinal axis and exists at least in a plane parallel to the planar surface, one of the frontside and backside having a recess on the longitudinal axis, the through hole being on the longitudinal axis and extending from the frontside to the backside;
a bearing having a spherical outer surface seated in the recess of the holder such that a center of curvature of the spherical outer surface is on the longitudinal axis; and
an optical-fiber collimator seated in a bore through the bearing, lateral dimensions of the optical-fiber collimator being undersized relative to the bore, the optical-fiber collimator facing in same direction as the frontside and including:
an optical fiber, and
a collimation lens.

2. The connectorized optical-fiber collimator of claim 1, wherein the outward-facing circumferential surface is cylindrical.

3. The connectorized optical-fiber collimator of claim 1, wherein the outward-facing circumferential surface is spherical.

4. The connectorized optical-fiber collimator of claim 1, wherein the outward-facing circumferential surface includes a conical surface, and wherein a largest circumference of the conical surface, orthogonally to the longitudinal axis, defines the circular circumference.

5. The connectorized optical-fiber collimator of claim 1, wherein the planar surface has a non-zero radial extent, with respect to the longitudinal axis.

6. The connectorized optical-fiber collimator of claim 1, wherein the frontside includes a concave spherical surface terminating in a circular edge, the planar surface being the circular edge.

7. The connectorized optical-fiber collimator of claim 1, wherein the holder and the bearing are made of glass.

8. The connectorized optical-fiber collimator of claim 1, wherein the holder is a disk and the bearing is a complete sphere penetrated by the bore.

9. The connectorized optical-fiber collimator of claim 1, wherein the recess is spherical.

10. The connectorized optical-fiber collimator of claim 1, wherein the recess is on the backside.

11. The connectorized optical-fiber collimator of claim 1, wherein the recess is on the frontside.

12. The connectorized optical-fiber collimator of claim 11, wherein the bearing protrudes from the recess beyond the planar surface, and an axial footprint of the bearing on the planar surface is surrounded by a radially-outermost portion of the planar surface.

13. The connectorized optical-fiber collimator of claim 11, wherein the bearing and a front end of the optical-fiber collimator are between the frontside and backside.

14. The connectorized optical-fiber collimator of claim 1, wherein (a) the optical-fiber collimator includes a collimator body seated in the bore of the bearing, (b) the collimation lens is secured to the collimator body, and (c) the holder, the bearing, and the collimator body are made of glass.

15. The connectorized optical-fiber collimator of claim 1, wherein the planar surface has surface flatness less than 1 micrometers.

16. The connectorized optical-fiber collimator of claim 1, wherein the cylindrical surface has surface flatness less than 160 micrometers.

17. The connectorized optical-fiber collimator of claim 1, wherein the collimation lens is at the center of curvature of the spherical outer surface.

18. A fiber-to-fiber coupling, comprising:
first and second instances of the connectorized optical-fiber collimator of claim 1, the planar surfaces of the first and second instances of the connectorized optical-fiber collimator being held directly or indirectly against each other, whereby the planar surfaces are parallel; and
a support structure supporting the outward-facing circumferential surfaces of the first and second instances of the connectorized optical-fiber collimator such that the outward-facing circumferential surfaces are concentric.

19. The fiber-to-fiber coupling of claim 18, wherein one of the first and second instances of the connectorized optical-fiber collimator has three rounded protrusions, protruding from the planar surface of the respective holder, whereby the two planar surfaces interface with each other via the rounded protrusions.

20. The fiber-to-fiber coupling of claim 18, further comprising a bracket holding three spheres, the bracket being disposed between the planar surfaces such that each of the three spheres spans between the planar surfaces.

21. A connectorized optical-fiber collimator mounted for fiber-free-space coupling, comprising:
the connectorized optical-fiber collimator of claim 1; and
a cylindrical block having a through hole, a cylindrical surface with same diameter as the outward-facing circumferential surface of the holder, and a planar surface;
a base;
a pair of wedges supported by the base and together forming a v-groove;
wherein (a) the outward-facing circumferential surface of the holder and the cylindrical surface of the cylindrical block are seated against the v-groove, (b) the planar surface of the cylindrical block is parallel to and registered against the planar surface of the holder, (c) the through hole of the holder is generally along and on the longitudinal axis, and (d) a height of the longitudinal axis above the base is a function of a distance between the wedges.
